(19) United States
(12) Patent Application Publication
(10) Pub. No.: US 2005/0099647 A1
(43) Pub. Date: May 12, 2005

(54) Print system and print control method

(75) Inventor: Takao Aichi, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/627,656

(22) Filed: Jul. 28, 2003

(30) Foreign Application Priority Data
Jul. 31, 2002 (JP) 2002-223582

(51) Int. Cl. G06F 15/00

(52) U.S. Cl. 358/1.15; 358/1.16

(57) ABSTRACT

This invention has as its object to generate print data using minimum resources in a terminal. A browser controller acquires a predetermined Web page from an Internet print server, and inputs the URL of a Web page to be printed and a print mode on that page. Printer information is transmitted to the server together with the input information. The server reads a Web page specified by the received URL, generates print data in a format that the printer can print in accordance with the printer information and print mode, and transmits that print data to the browser controller. The browser controller transmits the print data to the printer to print it out while receiving the print data.

### FIELD OF THE INVENTION

The present invention relates to a print control system and print control method and, more particularly, to a print control apparatus and print control method in a broadband printing system which efficiently generates print data for a print recording apparatus in a broad-range Internet environment or on a Web site, and feeds back data to the print recording apparatus of a terminal.

### BACKGROUND OF THE INVENTION

Conventionally, in order to output print data by a versatile color printer such as an ink-jet printer and the like, or a recording apparatus such as a multifunction printer or the like, a data transfer apparatus such as a personal computer or the like is normally required. Such data transfer apparatus is often used privately or for a home office (SOHO), and is connected to another data transfer apparatus, output apparatus, and the like via a wired or wireless communication network so as to offer more use applications.

Data printed by a color printer such as an ink-jet printer or the like is normally recorded in a raster bitmap format in which columns of pixels are arranged in a matrix, and addresses are one-dimensionally assigned to respective pixels along rows. Such raster data is often expressed by three primary colors, i.e., red (R), green (G), and blue (B), which are displayed as a continuous-tone, full-color image on a monitor connected to a personal computer or the like. For example, in an operating system (Windows 95, 98/ME/NT/2000, etc.) available from Microsoft Corporation, image data generated by application software is output for a display process, print process, and the like as RGB 24-bit data (8 bits×three colors) via a GDI (an abbreviation for Graphics Devices Interface; a standard function of rendering a line, circle, polygon, text, and the like). Based on the RGB 24-bit data (also called 16 million color data) output from the operating system, driver software of a recording apparatus, e.g., an ink-jet printer, normally generates print data to be input to that ink-jet printer.

However, if RGB data is input from the driver software of the recording apparatus to the recording apparatus, it is often inconvenient in term of the principles of additive color mixing (RGB) and subtractive color mixing (CMY) (in order to change the amounts of R, G, and B light components, the amounts of C, M, and Y components as complementary colors must be changed). For this reason, RGB data must be converted into cyan (C), magenta (M), and yellow (Y) data.

In practice, a recording apparatus such as an ink-jet printer or the like records black on a medium using black ink. This is for the following three reasons. First, C, M, and Y color agents (inks in case of an ink-jet printer) are chemically synthesized, and do not have an accurate complementary color relationship with theoretical R, G, and B components, and it is difficult for them to express black with a high OD (optical density) value. Second, color misregistration occurs due to low dot forming precision of an ink-jet printer, and it is difficult to express black with a high OD value. Third, cost can be reduced using an independent black color agent rather than using three, C, M, and Y colors. For this purpose, the driver applies a process for extracting black from RGB 24-bit data, and generates C, M, Y, and K (black) continuous-tone data.

On the other hand, it is difficult for an ink-jet printer among recording apparatuses to directly print continuous tone (multi-valued image). Generally, the ink-jet printer is a binary printer which expresses each pixel by whether or not one color dot is formed. Therefore, data to be finally input to the ink-jet printer are C, M, Y, and K binary data, and the driver software executes a binarization process of C, M, Y, and K continuous-tone data.

Control of the aforementioned general printer will be explained below with reference to FIG. 1. FIG. 1 shows the sequence of an image data generation process by application software, an output process of an operating system, and an output process of driver software, which are executed in a host computer or the like. Referring to FIG. 1, image data, which is generated using application software on a monitor in step S101, is output via a GDI in step S102. The output data is passed as image data, which is expressed by RGB 24 bits per pixel, to driver software of a printer in step S103. Note that the RGB 24-bit data has a raster format. FIG. 2 shows an example of image data in the raster format, in which each raster line includes N pixels (8 bits per color) in the horizontal direction, and M lines are included in the vertical direction. For example, if a print medium is a letter-size sheet, the basic resolution of an image is 360 dpi, and the print range is 8″ (horizontal)×10″ (vertical), N=2,880 and M=3,600.

After that, input correction such as gamma correction, source correction, and the like is applied to the image data in step S104. As is well known, gamma correction is intended to correct any gap between the human eye and actual density, and continuous tone is expressed by RGB at that time. The gamma correction corrects image data by multiplying each pixel value by a coefficient expressed by a gamma (γ) curve. As the coefficient, numerical values such as 1.0, 1.4, 1.8, 2.2, and the like are prevalently used.

In step S105, the RGB 24-bit data is converted into CMYK 32-bit, multi-valued data. At the same time, a black component (K) is extracted from C, M, and Y components.

In step S106, output correction is applied. In this output correction, image data is corrected in correspondence with the ink droplet size of the ink-jet printer. At this time, the image data is still CMYK 32-bit, multi-valued data. In step S107, a binarization process for converting continuous-tone data, i.e., multi-valued data into binary data is executed using known ED (error diffusion) or dither. In this case, the converted data has a format that the printer can process.

In this manner, Y, M, C, and K binary data are finally generated, as shown in FIG. 3. In the example of FIG. 3, Y, M, C, and K color data are arranged in the raster format. In case of such raster data, Y, M, C, and K raster data are output to a printer for respective rasters, i.e., for M rasters each including N pixels in FIG. 3. In this case, if the image size is a latter size, and the print range is 8″ (horizontal)×10″ (vertical), data per color amounts to 1,296,000 bytes (2,880×3,600/8), and data for four colors amount to 5 Mbytes or more. Hence, especially when an interface (parallel interface, USB, or the like) for making a communication between the printer and host computer has a low communication speed, compressed image data is output to the printer to reduce the data size, thus improving the total throughput.

However, as shown in FIG. 3, when Y, M, C, and K binary data finally generated by the printer driver are raster data, the printer must execute horizontal-vertical conversion (HV conversion) of the data arrangement upon printing, as shown in FIG. 5A that shows the flow in case of horizontal raster data. This is because a typical ink-jet printer is a serial printer. In a print head of the serial printer, nozzles used to form dots are arranged for respective colors in a direction nearly perpendicular to the scan direction of the head. For this reason, data must be formed to have serial addresses according to the nozzle arrangement upon outputting data to the print head, and so-called horizontal-vertical conversion (HV conversion) that converts addressing of raster data to such data must be applied. Due to such HV conversion load, the printer suffers throughput drop and generation of extra cost for an HV conversion circuit.

In order to solve such problem, upon generating Y, M, C, and K binary data in step S107 in FIG. 1, HV-converted image data is often generated. FIG. 6 shows a rendering example of yellow components shown in FIG. 3 to have a width of 2,880 dots. Binary data Y1 to Y24 for 24 bits, i.e., data for 3 bytes, form one column along the nozzle direction of the head in place of the raster direction. Then, 2,880 columns each for 24 bits, i.e., 24 nozzles are successively arranged. This format is called column data in contrast to raster data.

By arranging data in the column data format in this way, as shown in FIG. 5B, a printer engine can simply execute a print process by directly transferring received column data to a print head, thus improving the throughput of the printer. Also, since the need for an HV conversion circuit can be obviated, a cost reduction can also be achieved. Such technique is prevalent recently, since the entire system speed can be improved due to the presence of a high-speed CPU in a PC as a host computer even when the process of the printer driver is done within the PC. This technique is described in detail in Japanese Patent Application No. 10-213262.

This technique can provide a higher-precision print process by optimizing a process such as error diffusion and the like in correspondence with the number and arrangement order of nozzles of the print head upon binarization. For this purpose, the printer and host computer are connected via a two-way I/F, as shown in FIG. 7. The printer driver acquires information of the print head from the printer prior to a print process and efficiently generates data in correspondence with the number and arrangement order of nozzles of the print head.

The printer driver acquires information of the head temperature, head type, printer status, and the like from the printer as needed in addition to the above information, i.e., the number and arrangement order of nozzles. Based on the temperature information of the printer, the data output timing or density from the printer driver is changed to execute a print process without any load on the print head. Many printer systems acquire error information. Such error information can inform the operator of an out-of-paper state in the printer and an open/close state of a printer door, thus providing a user-friendly system.

The conventional print control systems, especially, the processes between the host computer and printer have been explained. In any of the above systems, a large-capacity memory (normally incorporated in the host computer) is required to store or process image data, as shown in FIG. 1. Also, a display device such as a display or the like is required to display print data. For this reason, a system that prints an image without using any host computer is limited. Recently, a product called a Web TV system as a combination of a normal television and an Internet function is commercially available so that everyone can easily access the Internet. Some Web TV system can directly output a print command and data by the Internet function. However, in such system, a television and devices such as a Web TV box 801 and the like are required, as shown in FIG. 8. The Web TV box 801 is connected to a home TV 802, and has a role of receiving or transmitting information from/to an Internet network 803 via a public line and router (and a hub as needed) 804. The Web TV box 801 normally comprises an OS such as Windows CE, OpenTV, or the like, e-mail and browser applications, a renderer (interpreter) such as an HTML engine for display and print, and the like, a print data generation memory, and a print data transmission/reception memory.

The Web TV box 801 comprises an interface with a printer 805, and can output raster data generated by the renderer to the printer, so as to control the printer to print it out. The Web TV box 801 is designed to easily access the Internet at home, but is equivalent to a normal host PC for the printer.

In this way, a print process of the printer requires an apparatus such as a host PC, Web TV box, or the like, which can serve as a master for the printer, and also many image processes, a large-capacity memory, and the like.

Furthermore, a system that directly outputs print data from a Web server or the like on the Internet to a printer on the terminal side via a recording apparatus such as a terminal PC or the like is available. In such system, since data is generated irrespective of the arrangement and state of the printer on the terminal side, the data cannot be efficiently generated in correspondence with the printer state or the shape of the print head.

Moreover, a technique (Japanese Patent Laid-Open No. 2001-43039) that downloads a desired printer driver via the Internet is known. However, this technique requires a print data process in a PC, and is not suited to a simple data transfer apparatus like an electrical home appliance.

### SUMMARY OF THE INVENTION

It is an object of the present invention to provide a technique that does not require any conventional print system, i.e., elaborate apparatuses such as a host PC, Web TV box, and the like required to print.

The present invention has been made in consideration of the aforementioned prior art, and has as its another object to provide a print control apparatus and print control method, which can fully exploit a two-way communication technique of the Internet and data processing performance on a Web server to reflect them on a new print technique, and can utilize a printer in many fields that allow Internet connection without following any conventional one-to-one concept like a printer vs. host PC.

As home appliances such as a digital television and the like which may become widespread in the future, Internet connection function built-in models are expected to prevail, and the chances to connect a printer as a peripheral device may increase. The present invention has as its still another object to provide a print control apparatus and print control method, which can inexpensively and simply provide a chance to print such as a Web browser window or the like to such so-called NonPC type home appliances (also called Internet appliances; to be also referred to as IA hereinafter) and apparatuses. Especially, the present invention inexpensively provides a system by utilizing a memory on a Web server since driver software requires a huge memory size in case of a print process at high resolution.

It is still another object of the present invention to provide a print control apparatus and print control method, which can reduce the load on host resources (memory and the like) by utilizing a server on the Internet for a data process of a printer driver, which is installed in a host even in a print system using the host, and are friendly for the user, since neither installation of a printer driver nor update of the driver version are required.

In order to achieve the above objects, the present invention comprises the following arrangement.

One aspect of the present invention adopts means which acquires information of a print head and status of a recording apparatus such as an ink-jet printer or the like connected to a home appliance such as a digital television or the like or a normal PC from that recording apparatus, sends browser (browse software) window data to be printed onto an upstream public line together with the acquired information, makes an internal printer data interpretation unit and printer information interpretation unit interpret these data using via a home page or the like, which has been set up in advance in a WWW server of a service provider or the like on the Internet, so as to generate appropriate data corresponding to the printer, feeds back the generated data to a browser of a terminal, and prints it out.

With this means, especially when an Internet device connected to a home appliance such as a digital television or the like is used, a data process is executed on a network without adding any extra memory for printer connection or any complicated control unit to the Internet device, and the processed data is reflected onto the Internet device as a terminal, thus easily providing a print process. Furthermore, when an Internet browser on a PC is used, a data process on the network can be executed by only installing a simple printer driver.

Alternatively, the present invention has the following arrangement.

A print control apparatus which can be connected to a server that generates print data on the basis of printer information and information to be printed, comprises: an acquisition unit for acquiring printer information from a printer connected to the apparatus; a transmission unit for transmitting information required to specify the information to be printed, and the printer information to the server; a reception unit for receiving print data from the server as a response; and a print control unit for controlling the printer to print the print data.

The printer information preferably contains at least one of the number of elements of a print head, an arrangement order of elements, a print system, and types of colors used.

Preferably, the apparatus further comprises a display which is connected to a computer network, and displays data provided by a server connected to the computer network, and wherein a location of the information to be printed is transmitted to the server via a window which is displayed on the display and is provided by the server.

Preferably, a print mode of the printer is input via the window which is displayed on the display, and the print mode is transmitted to the server together with the printer information.

The printer information preferably contains information that pertains to a position of a non-ejection nozzle, and image data is generated to control the printer to form an image using nozzles except for the non-ejection nozzle.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a flow chart showing a generation process of general print data;

FIG. 2 shows the arrangement of continuous-tone data;

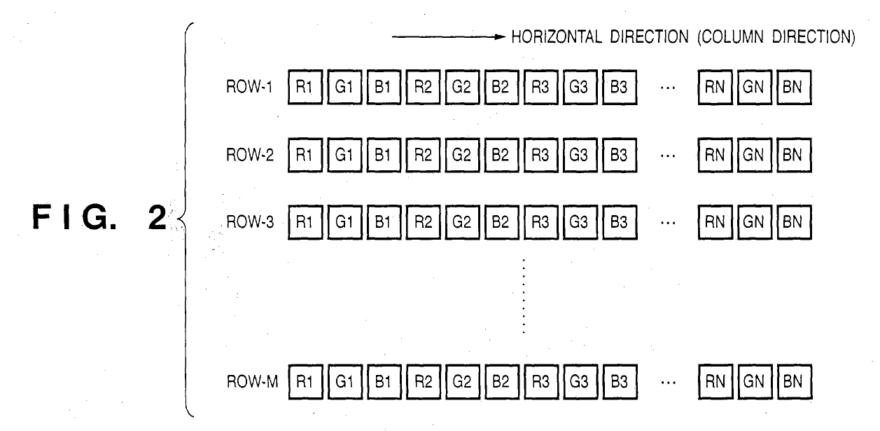

FIG. 3 shows the arrangement of binary data;

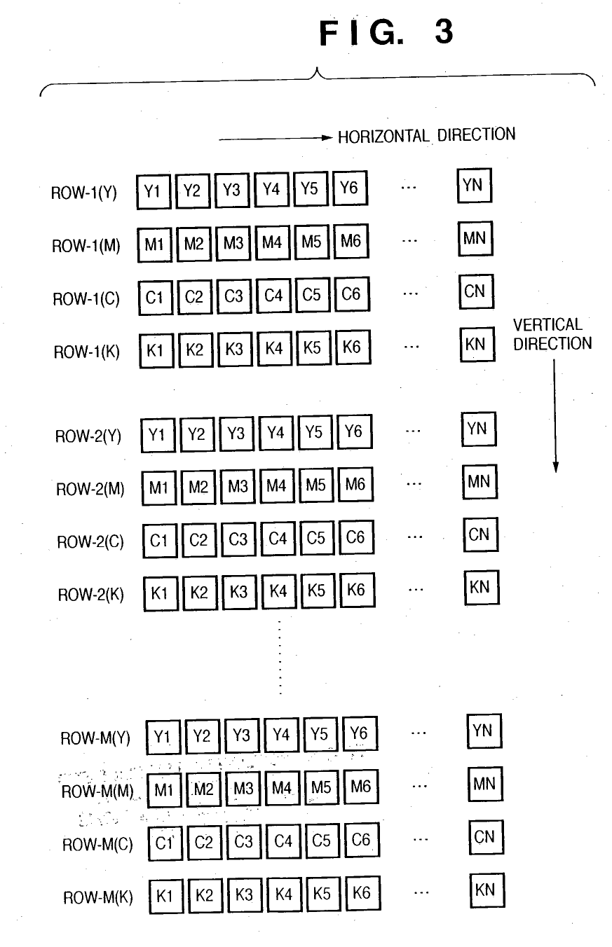

FIG. 4 shows a print head of a general ink-jet printer;

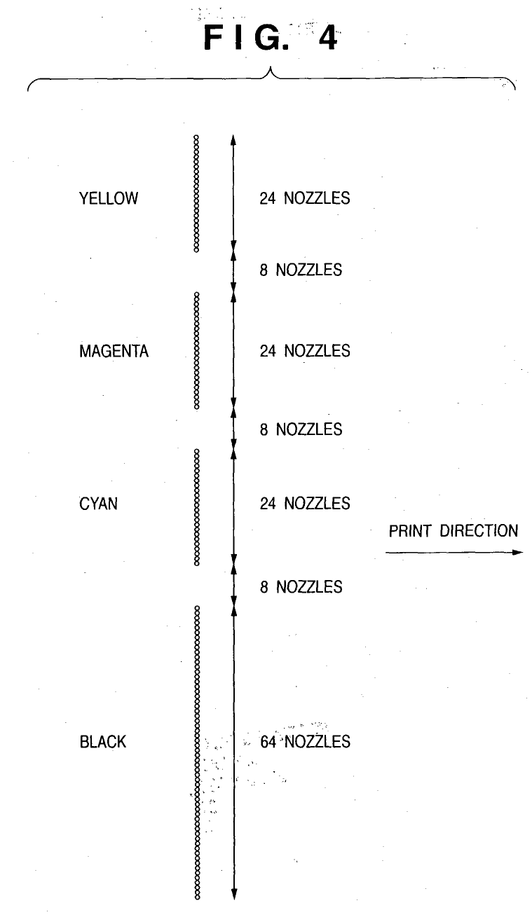

FIGS. 5A and 5B are charts showing different control processes corresponding to horizontal raster data and vertical column data;

FIG. 6 shows binary data of column data;

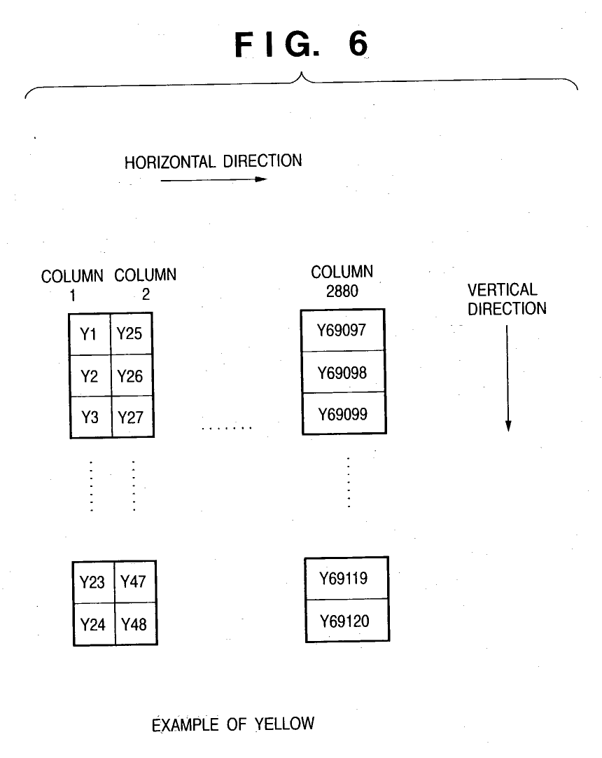

FIG. 7 shows the communication contents between a printer and printer driver;

FIG. 8 is a system block diagram of a Web TV and Internet network;

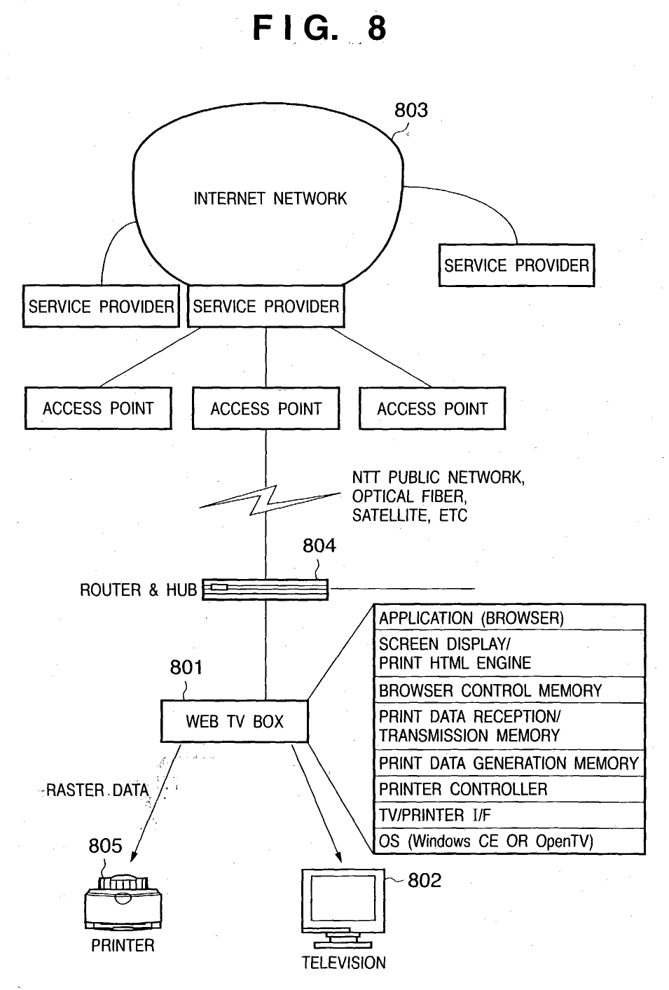

FIG. 9 is a system block diagram showing the first embodiment of the present invention;

FIG. 10 is a flow chart of the first embodiment of the present invention;

FIG. 11 shows browser windows used in the first and second embodiments of the present invention;

FIG. 12 is a partial flow chart of the first and second embodiments;

FIG. 13 is a system block diagram showing the second embodiment of the present invention; and

FIG. 14 is a flow chart of the second embodiment of the present invention.

FIG. 15 shows the method for printing data in raster format with an ink-jet head having a non-ejection nozzle.

FIG. 16 shows the method for printing data in column format with an ink-jet head having a non-ejection nozzle.

### DETAILED DESCRIPTION OF THE PREFERRED EMBODIMENTS

Preferred embodiments of the present invention will now be described in detail in accordance with the accompanying drawings.

### First Embodiment

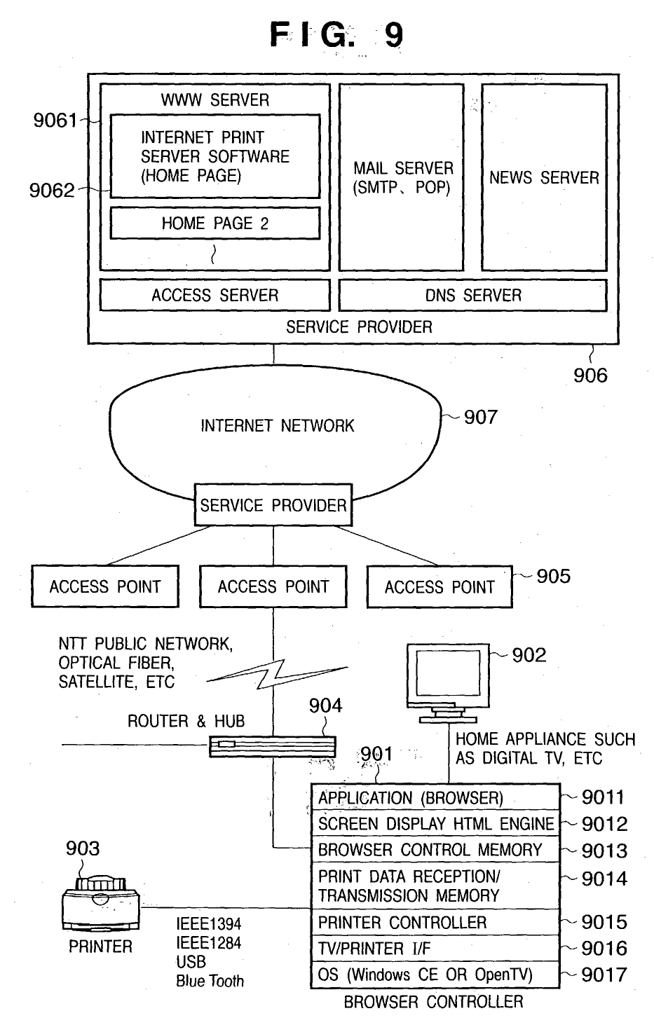

FIG. 9 is a system block diagram showing the arrangement of this embodiment. Referring to FIG. 9, a browser controller 901 is a characteristic feature of the present invention. The controller 901 is connected to or built in a NonPC home appliance (IA) such as a digital television 902 or the like, and is designed to mainly achieve Internet connection and a print system according to the present invention.

Unlike a known Internet connection device such as a Web TV box or the like, as can be seen from FIG. 9, since a basic print process is executed on a WWW server on an Internet network, as will be described later, the browser controller does not have any print data generation memory, since no print data need be generated in the browser controller. In the same way, no print HTML engine is required.

The browser controller 901 comprises a microprocessor and memory. The memory includes a browser control memory 9013 used to control a browser, and a print data reception/transmission memory 9014. Also, the controller 901 comprises, as a TV/printer interface 9016, a video interface, IEEE1394 interface, or the like required to connect the IA, and an IEEE1284 parallel interface, USB interface, IEEE1394 interface, or wireless interface (e.g., Bluetooth) required to connect a printer. Any of these interfaces are adopted on the condition that they can make two-way communications. Furthermore, the controller 901 comprises a network interface used to connect a router (or hub) 904 so as to establish Internet connection.

On the above arrangement, a basic OS, e.g., Windows CE available from Microsoft Corporation or an existing OS available from Open TV. Inc., is installed to execute input/output management of devices and management of an application. As the application, a Web browser 9011 is installed, and the user can enjoy services provided from a server 906 connected to the Internet via the browser 9011. As the browser, either a common browser such as Internet Explorer available from Microsoft Corporation or a unique browser may be adopted.

The controller 901 comprises a screen display HTML engine 9012 to control the IA 902 to make screen display such as a browser window and the like. The screen display HTML engine 9012 generates image data on the basis of a GUI window generated by the browser 9011, HTML data received from the server, and the like. This image data is transmitted to the IA 902 via the TV/printer interface 9016, and is displayed on the IA 902.

Furthermore, the browser controller 901 comprises a printer controller 9015. The printer controller 9015 manages communications with a printer 903 to reflect information acquired from the printer on the browser, and manages exchange of their data.

With the browser controller 901 having the aforementioned arrangement, when the operator designates a desired object to be printed using the browser window displayed on the IA 902 as a user interface, required data are combined and are output onto the Internet to have a predetermined server (to be referred to as an Internet print server hereinafter) as a destination.

The output data reaches an access point 905 via an intra-network such as the router 904 and the like and a public line. The access point 905 is present as a network operation center, and has a roll of accepting telephone line connection or connection via an optical fiber from the user. The data enters an Internet network 907 via the access point 905, and reaches the designated Internet print server 906.

The Internet print server 906 may be a general server managed by a service provider or the like. Such general server comprises a mail server (SMTP, POP) for managing mail messages such as e-mail messages and the like, a news server, and a WWW server 9061 as a core of the control of the present invention in addition to an access server for managing access from the user, and a DNS server for converting the IP address and domain name. The WWW server 9061 provides home pages and service information. A service provider normally manages a plurality of home pages and service information of Internet users. Of the general server, a server having an Internet print home page required to implement a sequence to be described later in a WWW server will be especially referred to as an Internet print server. Internet print server software is present in this home page. The purpose of this software is to interpret print information and print data uploaded from a terminal.

In place of a server provided by a general service provider, a dedicated Internet print server may be provided. In this case, print data is passed from a Web server to Internet print server software via a CGI (common gateway interface), and this software runs to interpret the print data. In this case, the Internet print server 906 provides an Internet print home page to a client. When the client inputs print data and the like to that home page, that data is passed to Internet print server software as a backend program, thus executing a process.

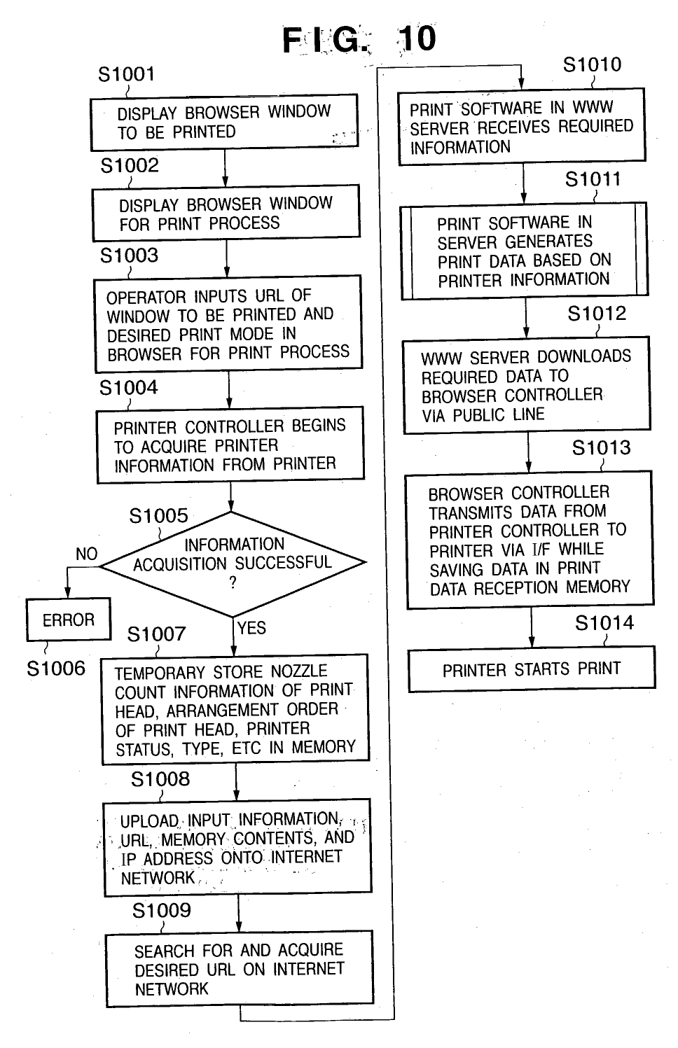

The flow of the system will be described in detail below using the flow chart shown in FIG. 10.

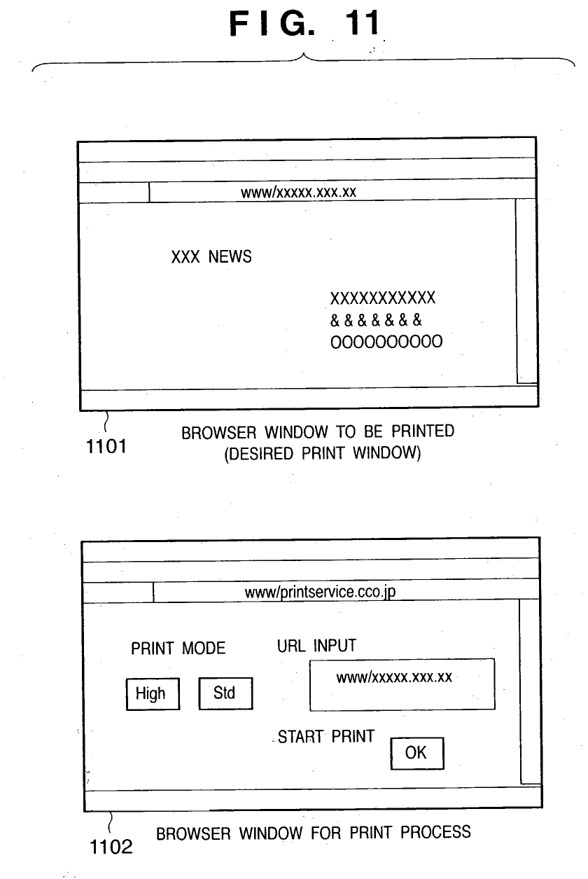

Referring to FIG. 10, control starts in step S1001. Initially, the operator displays a Web page window to be printed on the IA 902 in FIG. 9 like a window 1101 in FIG. 11. In this case, the operator launches the browser 9011 by the browser controller 901, and designates a desired URL (Uniform Resource Locator) on the browser. As a result, a server having the designated Web page transmits that Web page to the browser controller 901, which receives the Web page and displays it on the IA 902. Note that the Web page window display step is required for the operator to confirm its contents. Hence, when the URL of the Web page to be printed is known in advance, this step can be skipped.

After the URL of the desired Web page to be printed is settled, the operator designates the URL of the aforementioned Internet print home page from the browser 9011 in step S1002 to open a print window 1102 shown in FIG. 11 on the browser. Assume that the operator knows this URL in advance.

In step S1003, the operator inputs the URL of the Web page to be printed, and a print mode in a print process on the print window 1102. As the print mode, one of “High” for high image quality and “Low” for standard image quality can be designated in the example in FIG. 11.

After the print mode is designated, the printer controller 9015 in the browser controller 901 attempts to acquire printer information from the printer 903 via a two-way I/F in step S1004. It is checked in step S1005 if acquisition of information has succeeded. If acquisition has failed, it is determined that the printer is OFF or suffers any error, and the control advances to an error process in step S1006.

If it is determined in step S1005 that acquisition of information from the printer has succeeded, the control advances to step S1007 to temporarily store, in the print data transmission memory 9014, the printer information acquired from the printer 903, e.g., head information such as the number and arrangement order of nozzles of a print head and the like, printer status information, and the like.

In step S1008, the URL of the Web page to be printed and print mode information input in step S1003, and the IP address of the browser controller 901 are uploaded to the Internet print server 906 together with the stored printer information (steps S1008 and S1009). In step S1009, the uploaded data reaches the server 906 via the router 904, public line, access point 905, and the like while serving for the URL on the network. Finally, in step S1010 Internet print server software 9062, which is present in the Internet print home page in the WWW server or is associated with that home page, receives print information.

In step S1011, the Internet print server software 9062 generates print data on the basis of the received print data, printer information, and the like. The Internet print server software 9062 generates print data in a format that can be directly input to the printer, on the basis of the acquired information. Details of this sequence will be described later.

In step S1012, the data generated by the print server software 9062 is output from the sever 906 to the browser controller 901 via the public line. In step S1013, the browser controller 901 outputs the received print data to the printer via the printer controller 9015 while storing the received data in the reception memory 9014. The print data may be exchanged using FTP.

Upon receiving the print data, the printer 903 executes a print process according to that data.

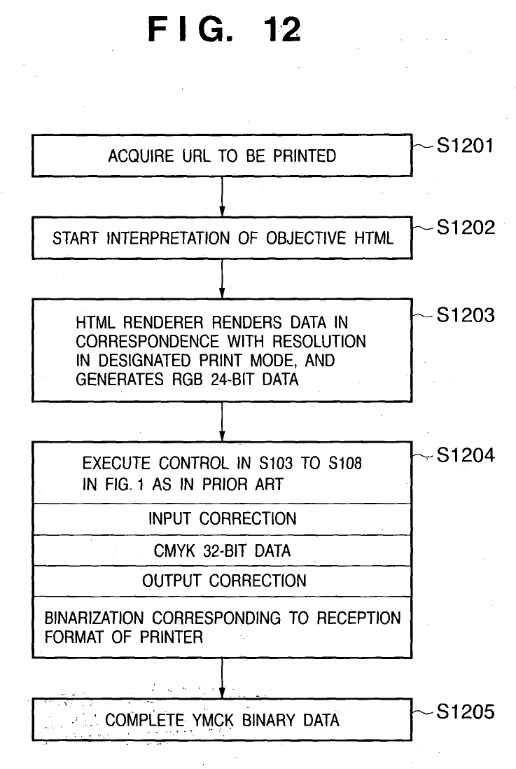

FIG. 12 is a flow chart for explaining the control contents in step S1011 in more detail. In step S1201, the Internet print server software acquires the URL of the Web page to be printed contained in the received data. In step S1202, the software reads out the Web page designated by that URL, and interprets the contents of that Web page (HTML file) described in HTML (Hyper Text Markup Language). Since most of browser windows acquired using URLs are described in HTML, this embodiment also explains HTML as the display language of the browser window.

The internet print server software 9062 has an HTML renderer (interpretation unit). This HTML renderer executes a process equivalent to that of a renderer used by a commercially available Web browser such as Internet Explorer available from Microsoft Corporation or the like so as to print a Web page. That is, in step S1203 the HTML renderer converts an objective HTML file into RGB 24-bit data.

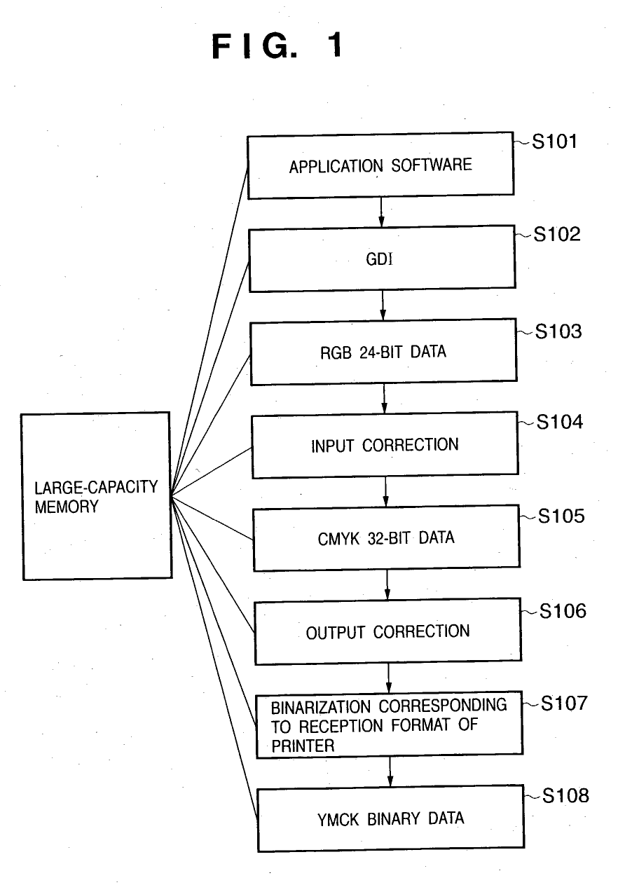

After that, the same processes as those in processing steps S103 to S108 in FIG. 1 are applied to the converted RGB 24-bit data in step S1204. That is, as has been explained in the prior art, RGB 24-bit, continuous-tone data undergoes input correction such as gamma correction, source correction, and the like to be converted into CMY 24-bit data. Then, black extraction is done to convert the CMY 24-bit data into CMYK 32-bit data. A binarization process based on error diffusion or dither is applied to the CMYK 32-bit data to generate CMYK binary data in correspondence with the reception format of the printer in step S1205. In this case, the printer information received from the browser controller 901 is referred to as in FIG. 1.

The printer information may contain information indicating the printer type. For example, if the printer is an electrophotography printer, input print data may have a raster format. Therefore, if the printer is an electrophotography printer, the host may skip HV conversion.

Some electrophotography printers can express grayscale to some extent by controlling the dot size. To such printer, input print data need not be completely binarized. Furthermore, if the printer is a dye sublimation printer, it can attain advanced grayscale expression. For this reason, it is desirable to transmit the availability of grayscale expression performance to the server. In this case, since the grayscale expression performance is determined by a print system, information associated with the print system may be transmitted.

Also, among ink-jet printers, some inexpensive low-end models express black by synthesizing C, M, and Y without using any black ink. For such printer, the black extraction process is not required. Hence, the printer information preferably contains information indicating whether or not black ink is used.

As described above, the Internet print server software installed in the server connected to the Internet executes substantially the same process as in a print data generation sequence, which is conventionally executed by a PC main body. The generated print data can be received by the browser controller 901 as a client terminal, and can be printed by the printer. For this reason, the client terminal need not comprise a memory or program required to generate print data, and can print as long as an environment required to use a printer and an environment required to establish Internet connection are available.

### Second Embodiment

The first embodiment has exemplified a printing system as a combination with a home appliance (IA) such as a digital television or the like. Also, the present invention can be practiced using the conventional print system, i.e., a combination of a personal computer and printer.

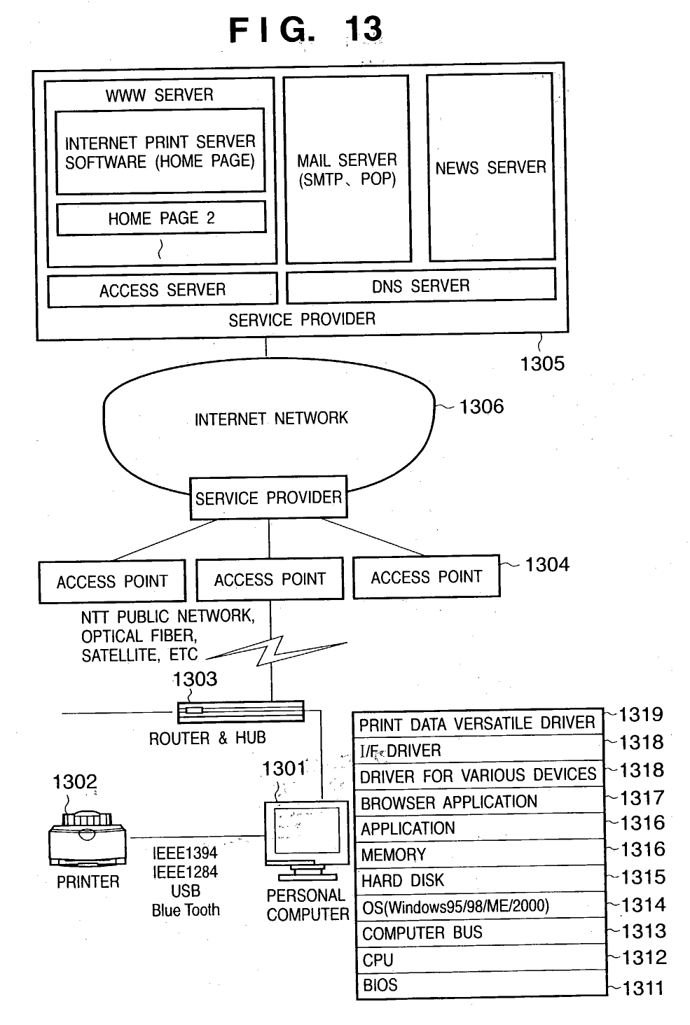

The system arrangement will be described below using FIG. 13. A PC 1301 in FIG. 13 is a general personal computer (PC). The PC 1301 comprises a BIOS 1311, i.e., a program for initially starting up the PC and managing inputs/outputs, a CPU 1312 as a central processing unit, a bus 1313 for connecting all inputs/outputs and the CPU, an OS 1314 for managing the arrangement of the entire system, a hard disk 1315 which stores a print data versatile driver of this embodiment, and user data, a versatile memory 1316 for temporarily storing print data of the present invention, normal application software 1316, a browser application 1317 such as Internet Explorer available from Microsoft Corporation, and the like, a driver 1318 for various peripheral devices, which is used for a mouse, keyboard, display, and the like, and also for a general printer, an interface driver 1318 for an interface such as an IEEE1284 parallel interface, USB, IEEE1394, Bluetooth, or the like, which connects the PC and printer, a print data versatile driver used in this embodiment, and the like. Since the arrangement other than the personal computer is the same as that in the first embodiment, a detailed description thereof will be omitted. Also, this system includes a printer 1312, router & hub 1303, access point 1304, service provider contents 1305, and Internet 1306.

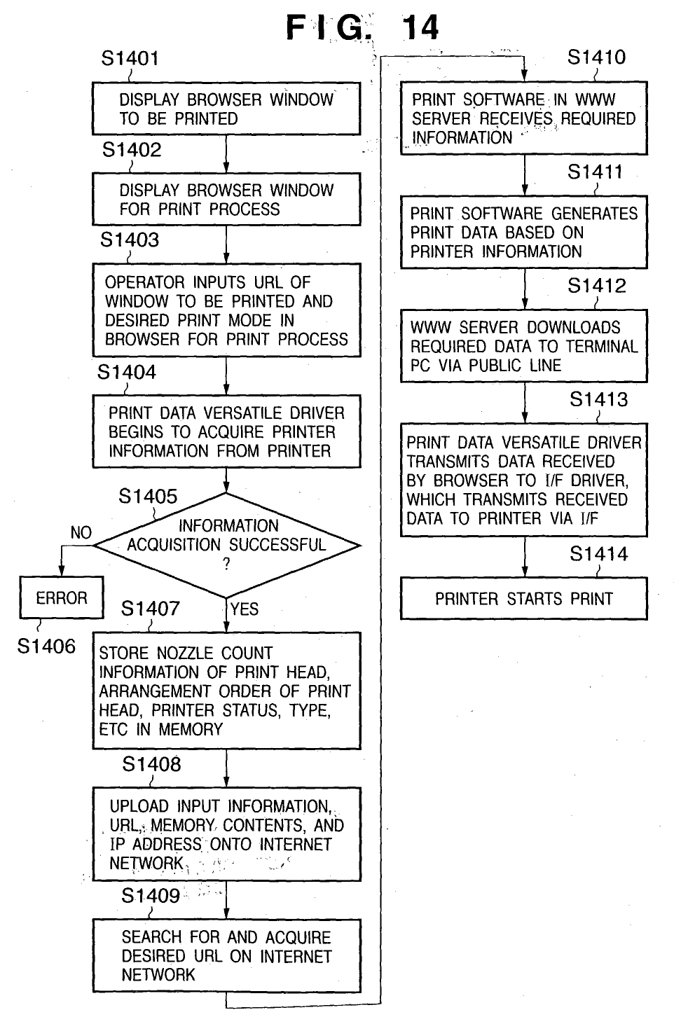

The second embodiment will be described below using the flow chart of FIG. 14.

The control starts from step S1401, and the operator displays a browser window (window 1101 in FIG. 11) to be printed on the PC 1301. After a desired print window is prepared, the operator opens a print process window (window 1102 in FIG. 11) as another new window in step S1402. This browser window is displayed by inputting a URL of a home page, which is set up in advance. In step S1403, the operator inputs the URL of the desired print window, and a print mode in a print process.

In step S1404, a print data versatile driver (a print data versatile driver 1319 in FIG. 13) reads required information from the printer via an I/F driver such as a port monitor the like included in the OS. Note that the print data versatile driver is a simple versatile driver which has only a function of simply outputting input data to the I/F driver, and a function of receiving data from the printer, unlike a printer driver stored in a general PC. The normal driver also has a function of executing various color processes and data processes, while the print data versatile driver of the present invention is specialized to only input/output control to cope with many printer models. Note that the print data driver need not be changed in correspondence with the data format or printer type since it is specialized to input/output control.

If it is determined in step S1405 that acquisition of information has failed, it is determined that the printer is OFF or suffers any error, and the control advances to an error process in step S1406. If it is determined in step S1405 that acquisition of information from the printer has succeeded, the control advances to step S1407 to temporarily store, in the print memory 1316, head information acquired from the printer, e.g., information such as the number and arrangement order of nozzles of a print head and the like, printer status information, and the like. In step S1408, the input URL and print mode information, and the IP address of a browser controller main body are uploaded onto the Internet together with the stored printer information. In step S1409, the uploaded data reaches a specific server in the service provider 1305 via the router 1303, public line, and access point 1304 in FIG. 13, while serving for the URL on the network. Finally, in step S1410 Internet print server software in a specific home page, which is assigned the input URL address and is present in the WWW server, receives print information.

In step S1411, the print server software generates print data on the basis of the received print data. FIG. 12 is a flow chart for explaining the control contents in step S1411 in more detail. The control contents of FIG. 12 will be explained again. In step S1201, the Internet print server software acquires the URL of the Web page to be printed. In step S1202, the software starts interpretation of HTML data designated by the acquired URL. An HTML renderer converts an objective HTML file into RGB 24-bit data in step S1203, and applies processes equivalent to those in steps S103 to S108 in FIG. 1 to the RGB 24-bit, continuous-tone data in step S1204. That is, as has been explained in the prior art, RGB 24-bit, continuous-tone data undergoes input correction such as gamma correction, source correction, and the like to be converted into CMY 24-bit data. Then, black extraction is done to convert the CMY 24-bit data into CMYK 32-bit data. A binarization process based on error diffusion or dither is applied to the CMYK 32-bit data to generate CMYK binary data in correspondence with the reception format of the printer in step. S1205.

That is, as in the first embodiment, the process in the print server software is substantially the same as the print data generation sequence executed in the conventional PC.

Referring back to FIG. 14, in step S1412 the data generated by the print server software is output to the PC 1301 in FIG. 13 via the public line with reference to the IP address. In step S1413, the browser application in the PC passes the received data to the print data versatile driver, which directly outputs the data to the I/F driver such as a port monitor or the like, thus transmitting data to the printer. After that, the printer starts a print process in step S1414.

As described above, according to the first and second embodiments, since the server on the Internet is used to process print data, print data processed on the Internet can be transmitted to the printer without directly executing any print data process on the IA or PC, which is connected to the printer. Especially, an apparatus such as an Internet appliance (home appliance such as a digital television or the like), to which an Internet controller that is not designed to print is connected, need not have any controller for a printer or any extra memory. Since principal processes are executed on the Internet, an inexpensive printing system can be provided. Furthermore, since printer information is acquired and data is generated on the basis of the number of nozzles and shape of a print head in correspondence with the reception format of the printer, the aforementioned method can be applied to various kinds of printer, and a driver or the like need not be updated.

Even when a print instruction is issued from a normal PC, once a basic print data versatile driver is stored, it is effective for every printers compatible to this system, and the operator need not install or update a printer driver. In addition, PC resources (load on a memory) can be reduced, and a comfortable PC environment can be provided.

As described above, according to the present invention, even when a terminal does not have any resources (memory, program, and the like) required to generate print data, print data corresponding to a printer to be used can be generated and printed. For this reason, a print instruction can be issued from a processor built-in electric product other than a computer.

### Another Embodiment

Printer information acquired in step S1004 in FIG. 10 by the printer controller of the first embodiment or in step S1404 in FIG. 14 by the printer driver of the second embodiment contains information that pertains to non-ejection nozzles.

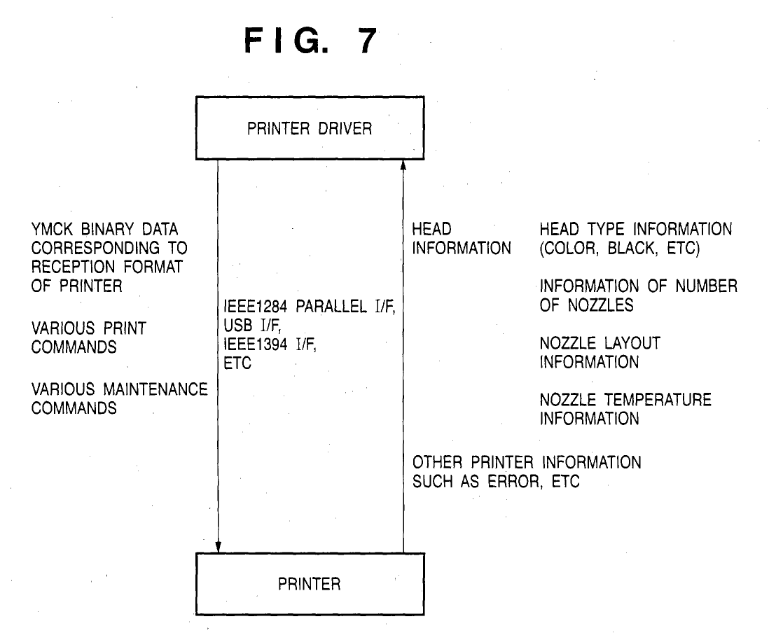

The printer transmits information indicating the positions of non-ejection nozzles to the printer controller or printer driver in addition to the head information shown in FIG. 7. In such case, the printer comprises a detection mechanism that detects non-ejection of ink. For example, an optical sensor is used for this purpose. The optical sensor comprises a light-emitting unit for emitting a light beam, and a light-receiving unit for receiving that light beam and converting it into an electrical signal. The optical sensor is fixed to the printer main body, so that the light beam is not parallel to the nozzle array, i.e., makes a predetermined angle with the nozzle array, and is intercepted by ink ejected from one nozzle. With this arrangement, the head is moved for each nozzle of the nozzle array to attempt ink ejection, and an output signal value from the optical sensor at that time is checked, thus detecting non-ejection for each nozzle. Of course, when a plurality of nozzle arrays are equipped, each nozzle array can similarly undergo non-ejection detection.

Upon receiving such non-ejection information, the printer controller or printer driver processes data as follows in the “binarization process corresponding to the reception format of the printer side” in step S107 in FIG. 1. In the following description, the printer controller or printer driver will be simply referred to as a “controller”.

(1) In Case of Horizontal Data

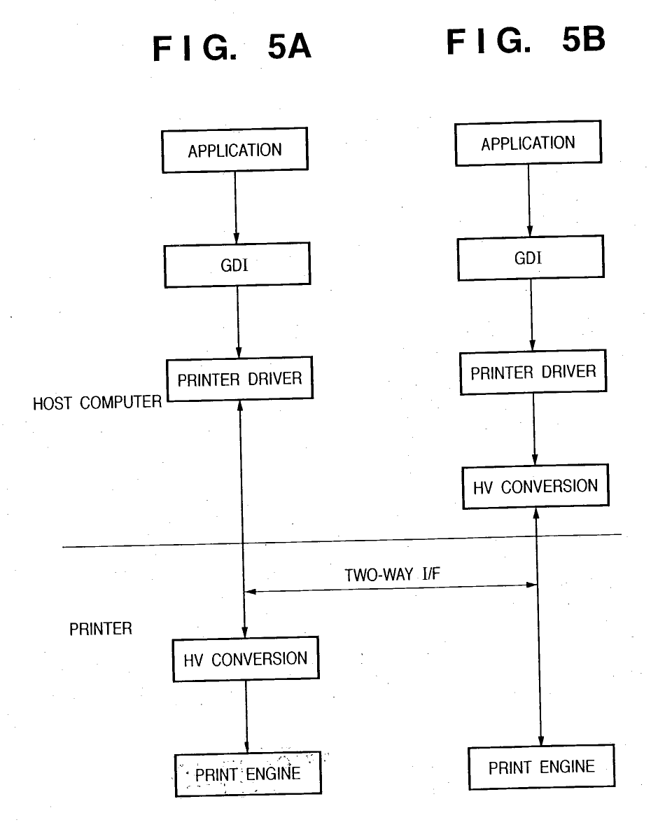

Horizontal data is transmitted from the printer controller or printer driver to the printer in case of FIG. 5A, and has a raster format.

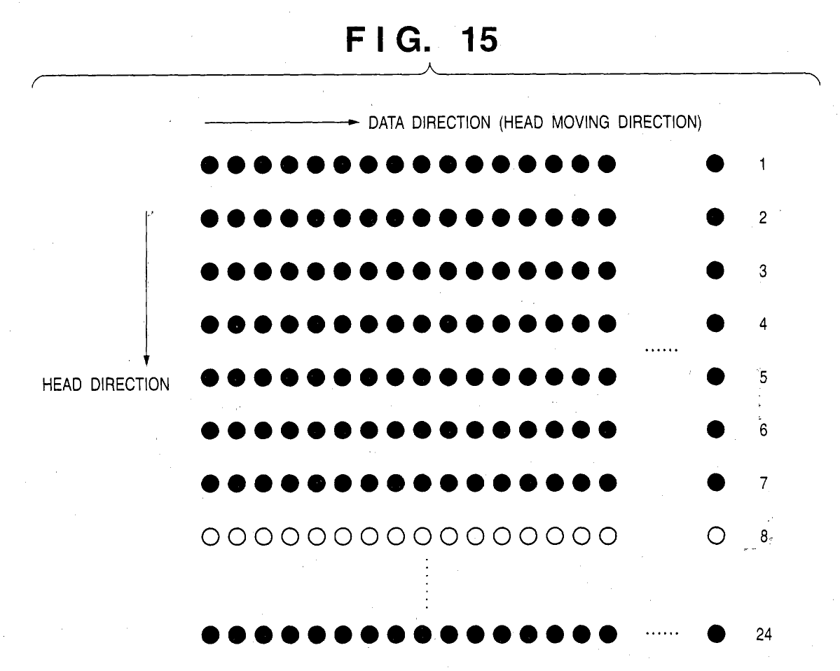

Assume that the controller has already acquired, from the printer, information indicating that the printer head has 24 nozzle as shown in FIG. 15 and, for example, nozzle No. 8 cannot eject any ink. If print control is done in the same manner as in a case using the head that works perfectly, a pixel sequence to be recorded by the non-ejection nozzle becomes blank. For example, in case of a specific color head of a color printer, a color to be recorded cannot be recorded in that pixel sequence.

Hence, the controller generates data and controls the printer, so as to use only a maximum one of available nozzle groups, which are segmented by the non-ejection nozzle, in a print process.

In the example shown in FIG. 15, available nozzle groups segmented by non-ejection nozzle No. 8 include a nozzle group including nozzles Nos. 1 to 7, and that including nozzles Nos. 9 to 24. The controller controls the printer to execute a print process using only the maximum nozzle group, i.e., the nozzle group including nozzles Nos. 9 to 24.

When the controller outputs data in the raster format according to the aforementioned principle, nozzles Nos. 1 to 7 cannot be used. Therefore, the data generation side, i.e., the controller generates data for nozzles Nos. 9 to 24 so as to output null data for nozzles Nos. 1 to 8 of the data for nozzles Nos. 1 to 24 to be output. That is, upon generating binary data to be transmitted to the printer, null data for eight lines of each color are stored in the memory first, and dot data for 16 lines are then stored in the memory. The generated data is transmitted to the printer. In this case, prior to data transmission, the controller notifies the printer that a unit paper feed amount is to be shortened by lines (eight lines in this example) corresponding in number to dots which are not used. As a result, the nozzle width to be used matches the feed amount, and an image to be formed can be printed. In this way, only the paper feed control is changed compared to a normal case, and the ink ejection control from the head can be done as usual in the printer.

Alternatively, the controller may generate data for nozzles Nos. 9 to 24 and output the generated data to the printer, which may control nozzles Nos. 1 to 8 not to eject ink. The controller controls to generate and store data for 16 lines used by nozzles Nos. 9 to 24. However, in this case, as for a paper feed process, the feed amount need be changed from that for 24 nozzles to that for 16 nozzles. Hence, the printer must internally control that process or the controller must change a feed amount command or the like.

(2) In Case of Column Data

When column data is to be transmitted to the printer, as shown in FIG. 5B, i.e., when the controller makes HV conversion (horizontal-vertical conversion), a normal print process can be executed using the printer having a non-ejection nozzle according to the same principle as in the above example.

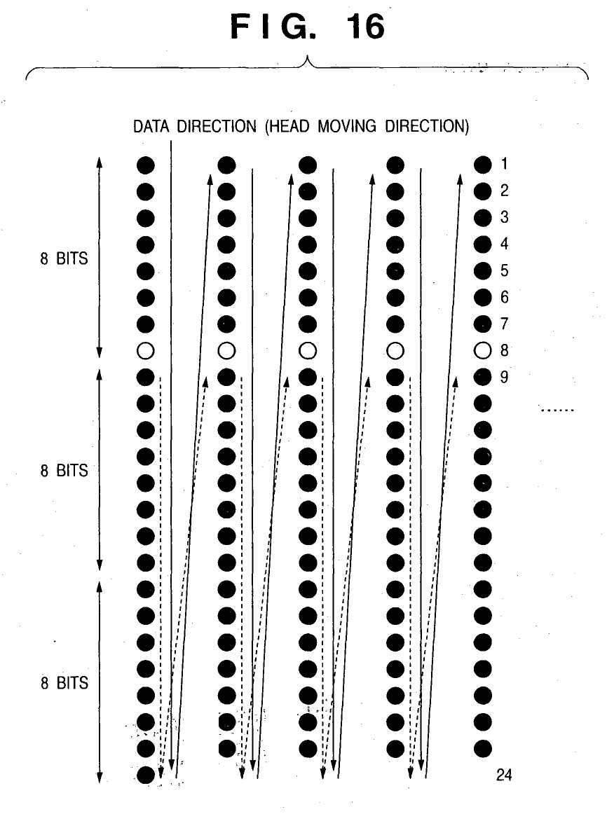

FIG. 16 shows an example wherein nozzle No. 8 cannot eject ink, as in FIG. 15. Normally, data are sequentially allocated and stored in correspondence with nozzles Nos. 1 to 24, as indicated by the solid arrows. By contrast, when nozzle No. 8 cannot eject ink, a data sequence indicated by the broken arrows is formed. That is, in consideration of continuity of available nozzles as in the raster data, nozzles that can be used in a print process are nozzles Nos. 9 to 24. This is also the result of selection of a maximum available nozzle group, as described above. The controller as the host side generates data corresponding to the remaining 16 nozzles and outputs the data to the printer in the column direction. The printer makes control not to eject ink from nozzles Nos. 1 to 8, and executes a print process by fully using nozzles Nos. 9 to 24. As in the raster data, line feed (paper feed) control in the vertical direction must be changed from an amount for 24 nozzles to that for 16 nozzles. For this purpose, paper feed control is made based on a paper feed command from the controller or inside the printer.

The controller may output null data for nozzles Nos. 1 to 8, which are not used, to execute the paper feed control. In this way, only the paper feed control is changed compared to a normal case, and the ink ejection control from the head can be done as usual in the printer.

With the above control, a high-quality print process can be realized using the printer having a non-ejection nozzle.

As many apparently widely different embodiments of the present invention can be made without departing from the spirit and scope thereof, it is to be understood that the invention is not limited to the specific embodiments thereof except as defined in the claims.

1. A print control apparatus which can be connected to a server that generates print data on the basis of printer information and information to be printed, comprising:
an acquisition unit for acquiring printer information from a printer connected to said apparatus;
a transmission unit for transmitting information required to specify the information to be printed, and the printer information to the server;
a reception unit for receiving print data from the server as a response; and
a print control unit for controlling the printer to print the print data.

2. The apparatus according to claim 1, wherein the printer information contains at least one of the number of elements of a print head, an arrangement order of elements, a print system, and types of colors used.

3. The apparatus according to claim 1, further comprising a display which is connected to a computer network, and displays data provided by a server connected to the computer network, and wherein a location of the information to be printed is transmitted to the server via a window which is displayed on said display and is provided by the server.

4. The apparatus according to claim 3, wherein a print mode of the printer is input via the window which is displayed on said display, and the print mode is transmitted to the server together with the printer information.

5. The apparatus according to claim 1, wherein the printer information contains information that pertains to a position of a non-ejection nozzle, and image data is generated to control the printer to form an image using nozzles except for the non-ejection nozzle.

6. A print system formed by connecting:
a print control apparatus of claim 1;
a server for generating print data on the basis of printer data and information to be printed; and
a printer.

7. A print control method using a server that generates print data on the basis of printer information and information to be printed, comprising:
an acquisition step of acquiring printer information from a connected printer;
a transmission step of transmitting information required to specify the information to be printed, and the printer information to the server;
a reception step of receiving print data from the server as a response; and
a print control step of controlling the printer to print the print data.

8. A computer program product comprising:
a code of an acquisition step of acquiring printer information from a connected printer;
a code of a transmission step of transmitting information required to specify the information to be printed, and the printer information to the server;
a code of a reception step of receiving print data from the server as a response; and
a code of a print control step of controlling the printer to print the print data.

9. The program product according to claim 8, wherein the printer information contains at least one of the number of elements of a print head, an arrangement order of elements, a print system, and types of colors used.

10. The program product according to claim 8, wherein a location of the information to be printed is transmitted to the server via a window which is displayed on a display for displaying data provided by the server connected to a computer network and is provided by the server.

11. The program product according to claim 10, a print mode of the printer is input via the window which is displayed on the display, and the print mode is transmitted to the server together with the printer information.

12. The program product according to claim 8, wherein the printer information contains information that pertains to a position of a non-ejection nozzle, and image data is generated to control the printer to form an image using nozzles except for the non-ejection nozzle.
